(19) United States
(12) Patent Application Publication
(10) Pub. No.: US 2012/0120103 A1
(43) Pub. Date: May 17, 2012

(54) ALIGNMENT CONTROL IN AN AUGMENTED REALITY HEADPIECE

(75) Inventors: John N. Border, Walworth, NY (US); John D. Haddick, San Rafael, CA (US)

(73) Assignee: Osterhout Group, Inc., San Francisco, CA (US)

(21) Appl. No.: 13/358,229

(22) Filed: Jan. 25, 2012

Related U.S. Application Data
(63) Continuation-in-part of application No. 13/037,324, filed on Feb. 28, 2011.
Application No. 13/037,324 is a continuation-in-part of application No. 13/037,335, filed on Feb. 28, 2011.
(60) Provisional application No. 61/308,973, filed on Feb. 28, 2010.
(60) Provisional application No. 61/373,791, filed on Aug. 13, 2010.
(60) Provisional application No. 61/382,578, filed on Sep. 14, 2010.
(60) Provisional application No. 61/410,983, filed on Nov. 8, 2010.
(60) Provisional application No. 61/429,445, filed on Jan. 3, 2011.
(60) Provisional application No. 61/429,447, filed on Jan. 3, 2011.
(60) Provisional application No. 61/308,973, filed on Feb. 28, 2010.
(60) Provisional application No. 61/373,791, filed on Aug. 13, 2010.
(60) Provisional application No. 61/382,578, filed on Sep. 14, 2010.
(60) Provisional application No. 61/410,983, filed on Nov. 8, 2010.
(60) Provisional application No. 61/429,445, filed on Jan. 3, 2011.
(60) Provisional application No. 61/429,447, filed on Jan. 3, 2011.

(51) Int. Cl. G09G 5/00

(52) U.S. Cl. 345/633

(57) ABSTRACT

This patent discloses a method for providing an augmented image in a see-through head mounted display. The method includes capturing an image of a scene containing objects and displaying the image to a viewer. The method also includes capturing one or more additional image(s) of the scene in which the viewer indicates a misalignment between the displayed image and a see-through view of the scene. The captured images are then compared to determine an image adjustment to align corresponding objects in displayed images to the objects in the see-through view of the scene. This method provides augmented image information that is displayed in correspondence to the image adjustments so the viewer sees an augmented image comprised of the augmented image information overlaid and aligned to the see-through view.

### CROSS REFERENCE TO RELATED APPLICATIONS

The present application is a continuation-in-part of and claims priority to U.S. patent application Ser. No. 13/037,324, filed 28 Feb. 2011, now U.S. Pat. No. ______, and to U.S. patent application Ser. No. 13/037,335, also filed on 28 Feb. 2011, now U.S. Pat. No. ______, both of which are hereby incorporated by reference in their entirety.

This application also claims the benefit of the following provisional applications, each of which is hereby incorporated by reference in its entirety:

U.S. Provisional Patent Application 61/308,973, filed Feb. 28, 2010; U.S. Provisional Patent Application 61/373,791, filed Aug. 13, 2010; U.S. Provisional Patent Application 61/382,578, filed Sep. 14, 2010; U.S. Provisional Patent Application 61/410,983, filed Nov. 8, 2010; U.S. Provisional Patent Application 61/429,445, filed Jan. 3, 2011; and U.S. Provisional Patent Application 61/429,447, filed Jan. 3, 2011.

### FIELD OF THE INVENTION

The present disclosure pertains to augmented reality imaging with a see-through head mounted display.

### BACKGROUND

See-through head mounted displays provide a viewer with a view of the surrounding environment combined with an overlaid displayed image. The overlaid image can be semitransparent so that the overlaid displayed image and the view of the surrounding environment are seen simultaneously. In different modes of operation, a see-through display can be transparent, semitransparent or opaque. In the transparent mode, the view of the environment is unblocked and an overlaid displayed image can be provided with low contrast. In the semitransparent mode, the view of the environment is partially blocked and an overlaid displayed image can be provided with higher contrast. In the opaque mode, the view of the environment is fully blocked and an overlaid displayed image can be provided with high contrast.

In augmented reality imaging, additional information is provided that relates to the surrounding environment. Typically, in augmented reality imaging, objects in the surrounding environment are identified in images of the surrounding environment and augmented image content that relates to the objects is provided in an augmented image. Examples of augmented image content that can be provided in augmented images includes: address labels for buildings; names for stores; advertising for products; characters for virtual reality gaming and messages for specific people. For augmented reality imaging to be effective, it is important for the augmented image content to be aligned with the objects from the surrounding environment in the augmented images.

However, in see-through head mounted displays, the view of the surrounding environment is not necessarily aligned with the displayed image. Variations in the location of the display area as manufactured, variations in the way that a viewer wears the see-through head mounted display, and variations in the viewer's eye characteristics can all contribute to misalignments of the displayed image relative to the see-through view. As a result, adjustments are needed in see-through head mounted displays to align the displayed image to the see-through view so that augmented image content can be aligned to objects from the surrounding environment in augmented images.

In U.S. Pat. No. 7,369,101, a light source is provided with a see-through head mounted display to project a marker onto a calibration screen. The displayed image is adjusted in the see-through head mounted display to align the displayed image to the projected marker. While this technique does provide a method to correct lateral and longitudinal misalignment, it does not correct for differences in image size, also known as magnification, relative to the see-through view. In addition, the approach of projecting a marker onto the scene is only practical if the scene is within a few meters of the see-through head mounted display, the projected marker would not be visible on a distant scene.

In U.S. Pat. Appl. Publ. 20020167536, an alignment indicator is generated in the image to be displayed and the indicator is aligned to the see-through view by the viewer manually moving the device relative to the viewer. This invention is directed at a handheld see-through display device which can be moved within the viewer's field of view and is not applicable to a head mounted display where the display is mounted on the viewer's head.

In the article “Single point active alignment method (SPAAM) for optical see-through HMD calibration for AR” by M. Tuceryan, N. Navab, Proceedings of the IEEE and ACM International Symposium on Augmented Reality, pp. 149-158, Munich, Germany October 2000, a method of calibrating a see-through head mounted display to a surrounding environment is presented. The method is for a see-through head mounted display with an inertial tracking device to determine the movement of the viewer's head relative to the surrounding environment. Twelve points are collected wherein the viewer moves their head to align virtual markers in the displayed image with a single point in the surrounding environment. For each point, data is gathered from the inertial tracking device to record the relative position of the viewer's head. A click on an associated mouse is used to indicate the viewer has completed the alignment of each point and to record the inertial tracker data. In the article “Practical solutions for calibration of optical see-through devices”, by Y. Genc, M. Tuceryan, N. Navab, Proceedings of International Symposium on Mixed and Augmented Reality (ISMAR '02), 169-175, Darmstadt, Germany, 2002 a two stage approach to alignment of a displayed image in a see-through head mounted display is presented based on the SPAAM technique. The two stage approach includes an 11 point offline calibration and a two point user based calibration. All of the points in this two stage approach to alignment are collected by moving the see-through head mounted display to align virtual markers in the displayed image with a single point in the real world and a head tracker is used to determine the relative positions of the see-through head mounted display for each point.

In U.S. Pat. No. 6,753,828, a 3D marker is generated in a head mounted stereo see-through display. The 3D marker is visually aligned by the viewer with a designated point in the real world and calibration data is gathered. This process is repeated for several positions within the space that will be used for augmented reality. A model of the augmented reality space is built using the calibration data that has been gathered.

### SUMMARY

One embodiment provides a method for aligning a displayed image in a see-through head mounted display to the see-through view perceived by the viewer. The combined image comprised of the displayed image overlaid on the see-through view provides an augmented reality image to the viewer. The method includes capturing a first image of a scene with a camera included in the see-through head mounted display device wherein the scene has objects. The captured first image is then displayed to a viewer using the see-through head mounted display device so that the displayed image and the see-through view of the scene are both visible. One or more additional image(s) of the scene are captured with the camera in which the viewer indicates a misalignment between the displayed first image and a see-through view of the scene. The captured images are then compared with each other to determine an image adjustment to align corresponding objects in displayed images to objects in the see-through view of the scene. Augmented image information is then provided which includes the determined image adjustments and the augmented image information is displayed to the viewer so that the viewer sees an augmented image comprised of the augmented image information overlaid on the see-through view.

### BRIEF DESCRIPTION OF THE DRAWINGS

FIG. 1 is an illustration of a head mounted see-through display device;

FIG. 2 is an illustration of a scene and the associated displayed image as seen from the viewer's perspective in both eyes;

FIG. 3 is an illustration of a combined view as seen by the viewer's right eye wherein a displayed image of the scene is overlaid on a see-through view of the scene and the two images are not aligned;

FIG. 4 is an illustration of a combined view of a scene wherein the viewer uses a finger gesture to indicate the perceived location of an object (the window) in the displayed image that is not aligned with the see-through view;

FIG. 5 is an illustration of a captured image of the viewer's finger gesture indicating the object (the window) location as shown in FIG. 4;

FIG. 6 is an illustration of a see-through view as seen by the viewer including the viewer's finger gesture indicating the location of the object (the window) in the see-through view;

FIG. 7 is an illustration of a captured image of the viewer's finger gesture indicating the object (the window) location as shown in FIG. 6;

FIG. 8 is an illustration of a combined view as seen by the viewer's right eye wherein the displayed image of the scene is overlaid on the see-through view of the scene and the two images are aligned on an object (the window);

FIG. 9 is an illustration of a combined view of a scene and the two images are aligned on an object (the window). The viewer uses a finger gesture to indicate the perceived location of another object (the car tire) in the displayed image that is not aligned with the see-through view;

FIG. 10 is an illustration of a captured image of the viewer's finger gesture indicating the another object (the car tire) location as shown in FIG. 9;

FIG. 11 is an illustration of a see-through view as seen by the viewer including the viewer's finger gesture indicating the location of the another object (the car tire) in the see-through view;

FIG. 12 is an illustration of a captured image of the viewer's finger gesture indicating the another object (the car tire) location as shown in FIG. 11;

FIG. 13 is an illustration of a combined view as seen by the viewer's right eye wherein the two images are aligned on the object (the window) and resized to align the another object (the car tire);

FIG. 14A is an illustration of a combined view augmented reality image as seen by the viewer's right eye wherein a displayed label (the address) is overlaid onto an object (the house) in the see-through view and the label is aligned to the object;

FIG. 14B is an illustration of a combined view augmented reality image as seen by the viewer's right eye wherein augmented image information in the form of displayed objects (the tree and bushes) are overlaid onto objects (the car and house) in the see-through view and the displayed objects are aligned to the objects in the see-through view;

FIG. 15 is an illustration of a scene and the associated displayed image as seen from the viewer's perspective in both eyes. A marker is visible in the left eye displayed image which indicates the area for the first alignment between the displayed image and the see-through view;

FIG. 16 is an illustration of a combined view as seen by a viewer in the left eye wherein a displayed image of the scene is overlaid on a see-through view of the scene and the two images are not aligned. A marker indicates a first area for alignment;

FIG. 17 is an illustration of a combined view as seen by a viewer in the left eye wherein a displayed image of the scene is overlaid on a see-through view of the scene and the viewer has moved their head to align objects (the roof) in the two images in the area of the marker;

FIG. 18 is an illustration of a combined view as seen by a viewer in the left eye wherein a displayed image of the scene is overlaid on a see-through view of the scene and the two images have been aligned in one area and a marker indicates a second area for alignment;

FIG. 19 is an illustration of a combined view as seen by a viewer in the left eye wherein a displayed image of the scene is overlaid on a see-through view of the scene and objects (the car tire) in the two images have been aligned in a second area;

FIG. 20 is an illustration of a combined view as seen by a viewer in the left eye wherein the displayed image of the scene is overlaid on the see-through view of the scene and the two images are aligned in the two areas of the markers by shifting and resizing the displayed image;

FIG. 21 is a flow chart of the alignment process used to determine image adjustments to align displayed images with the see-through view seen by the viewer; and

FIG. 22 is a flow chart for using the determined image adjustments to display augmented image information with corresponding object as seen the viewer in the see-through view.

### DETAILED DESCRIPTION

In a see-through display, a displayed image can be viewed by a viewer at the same time that a see-through view of the surrounding environment can be viewed. The displayed image and the see-through view can be viewed as a combined image where one image is overlaid on the other or the two images can be simultaneously viewed in different portions of the see-through display that is viewable by the viewer.

To provide an effective augmented reality image to a viewer, it is important that the augmented image information is aligned relative to objects in the see-through view so that the viewer can visually associate the augmented image information to the correct object in the see-through view. The invention provides a simple and intuitive method for indicating misalignments between displayed images and see-through views along with a method to determine the direction and magnitude of the misalignment so that it can be corrected by changing the way that the displayed image is presented to the viewer.

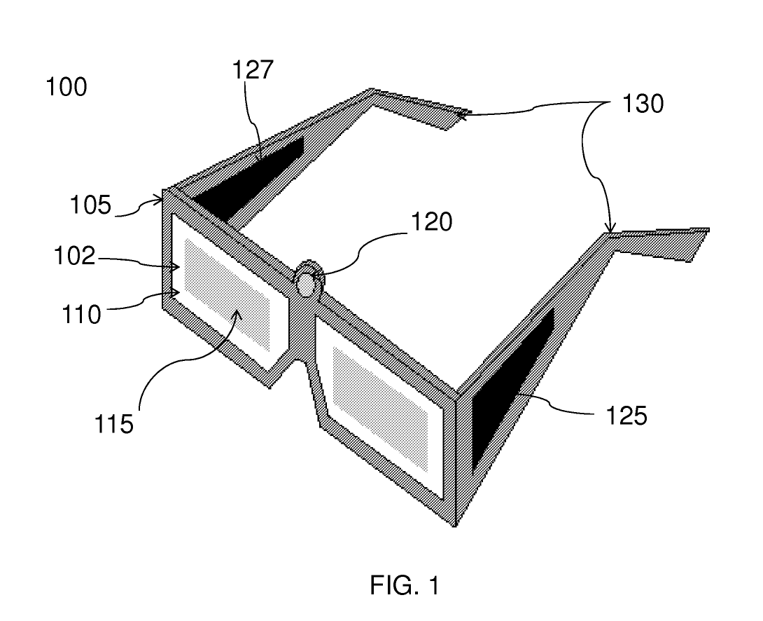

FIG. 1 shows an illustration of a head mounted see-through display device 100. The device includes a frame 105 with lenses 110 that have display areas 115 and clear areas 102. The frame 105 is supported on the viewer's head with arms 130. The arms 130 also contain electronics 125 including a processor to drive the displays and peripheral electronics 127 including batteries and wireless connection to other information sources such as can be obtained on the internet or from localized servers through Wifi, Bluetooth, cellular or other wireless technologies. A camera 120 is included to capture images of the surrounding environment. The head mounted see-through display device 100 can have one or more cameras 120 mounted in the center as shown or in various locations within the frame 105 or the arms 130.

To align images in a see-through head mounted display, it is necessary to know at least two different points in the images where corresponding objects in the images align. This allows calculations for shifting the images to align at a first point and resizing to align the second point. This assumes that the two images are not rotationally misaligned and the images are not warped or distorted. As shown in FIG. 1, the see-through head mounted display device 100 includes a camera 120 capturing images of the surrounding environment. For digital cameras it is typical in the industry to correct for distortions in the image during manufacturing. Rotational alignment of the camera 120 in the frame 105 also typically accomplished during manufacturing.

In an embodiment of the invention, the viewer uses a finger gesture to indicate misalignments between a captured image of the surrounding environment that is displayed on the see-through head mounted display, and the see-through view of the surrounding environment as seen by the viewer.

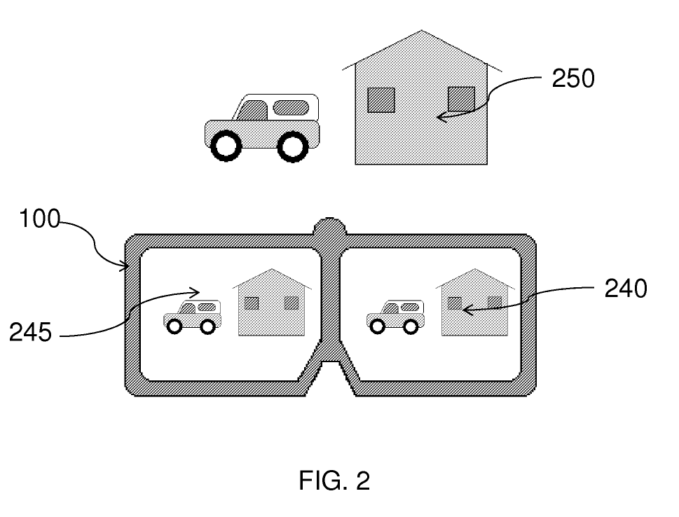

FIG. 2 is an illustration of a scene 250 and the associated displayed images 240 and 245 as seen from behind and slightly above the viewer's perspective in both eyes. The displayed images 240 and 245 as shown in FIG. 2 have been captured by the camera 120 of the scene in front of the viewer. The images 240 and 245 can be the same image, or for the case where the see-through head mounted display device 100 has two cameras 120 (not shown), the images can be of the same scene but with different perspectives as in a stereo image set for three dimensional viewing.

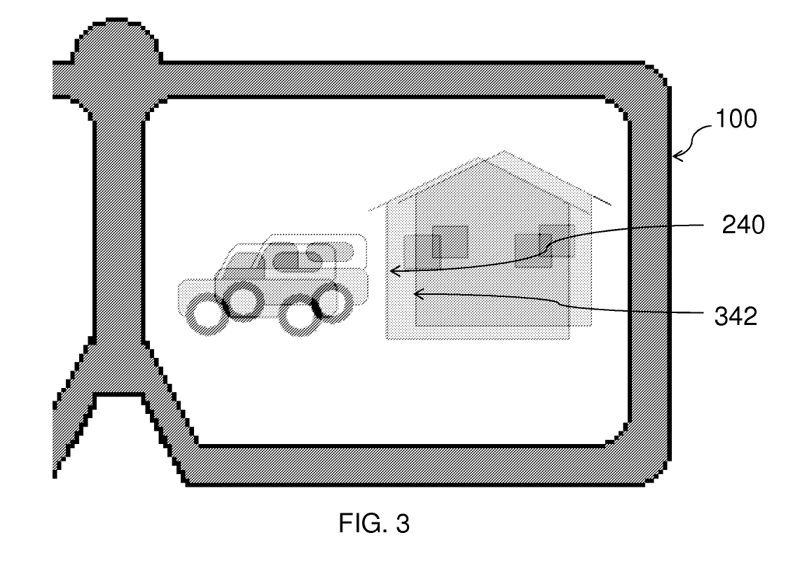

FIG. 3 is an illustration of a combined view as seen by the viewer's right eye wherein a displayed image 240 of the scene is overlaid on a see-through view 342 of the scene. The displayed image 240 shown in FIG. 3 has been captured by the camera 120 and is then displayed on the see-through head mounted display device 100 as a combined image where the displayed image 240 appears as a semi-transparent image that is overlaid on the see-through view 342. As can be seen in FIG. 3, the displayed image 240 and the see-through view 342 are misaligned as perceived by the viewer. The misalignment between the displayed image 240 and the see-through view 342 can vary with changes in viewer or with changes in the way that the viewer wears the see-through head mounted display device 100 each time the device is used. As a result, the invention provides a simple and intuitive method for correcting for misalignments.

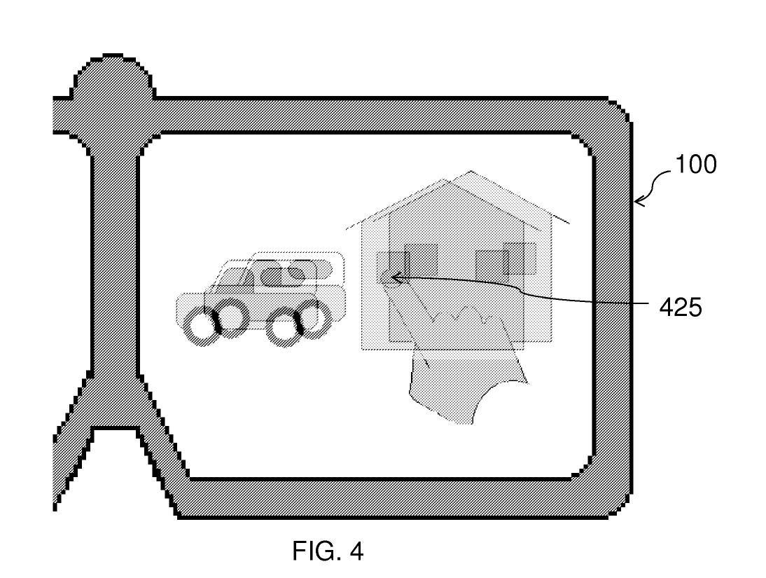

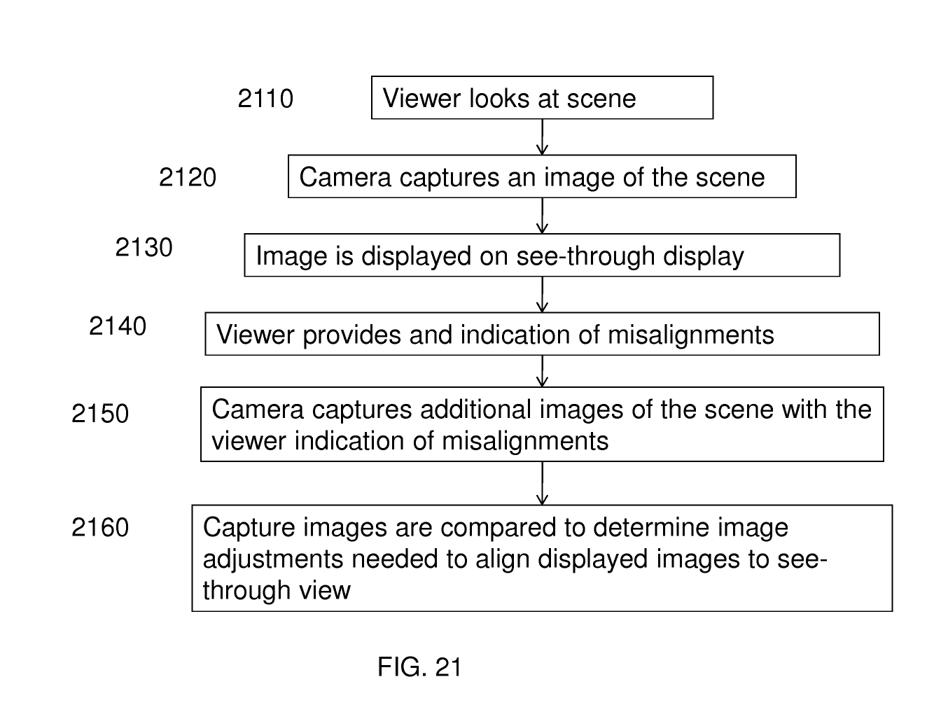

A method for determining misalignments is illustrated in FIGS. 3-13, and the flow chart shown in FIG. 21. In an embodiment of the invention, the camera 120 is used to capture a first image of a scene in front of the viewer. The captured first image is then displayed as a semitransparent image on the see-through head mounted display device 100, so that the viewer sees the displayed image overlaid on the see-through view of the same scene in front of the viewer such as is shown in FIG. 3. The viewer then selects a first object in the displayed image to use for determining misalignments. The viewer then uses their finger to indicate the perceived location of the selected object in the displayed image as shown in FIG. 4, in this example the viewer is shown indicating the window as the selected first object.

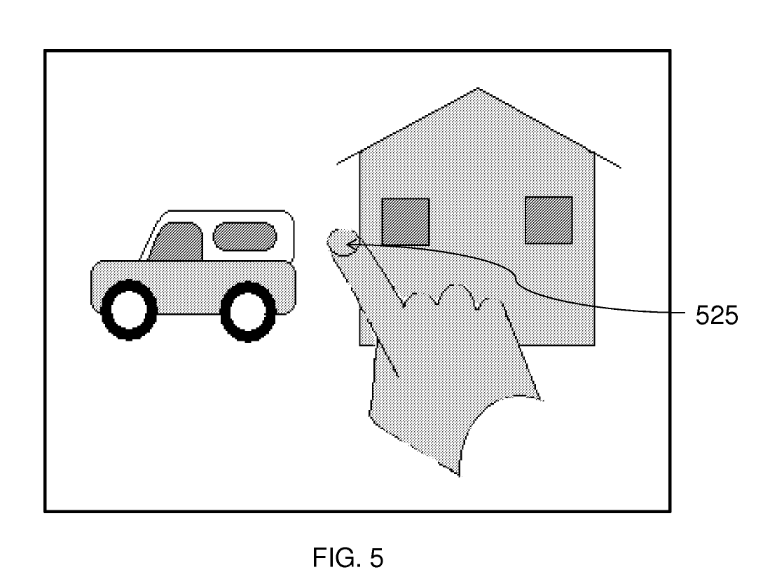

As can be seen in FIG. 4, the displayed image is overlaid on the see-through view of the scene which includes the viewer's finger 425. A second image is then captured by the camera 120 that includes the finger gesture of the viewer indicating the perceived location of the first object as shown in FIG. 5. Due to misalignment between the see-through view and images captured by the camera 120 and different perspectives of the scene (also known as parallax) between the camera 120 and the viewer's right eye, there is a misalignment in the second image between the viewer's finger 525 and the selected first object (the window) as shown in FIG. 5. The misalignment of the finger to the selected first object as seen in the second image can be different depending on the relative locations and associated perspectives of the scene provided by the camera 120 and the viewer's eye.

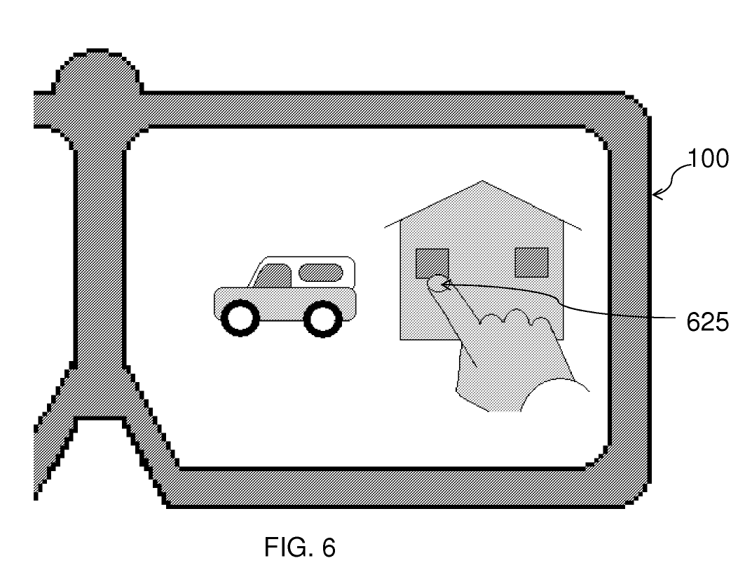

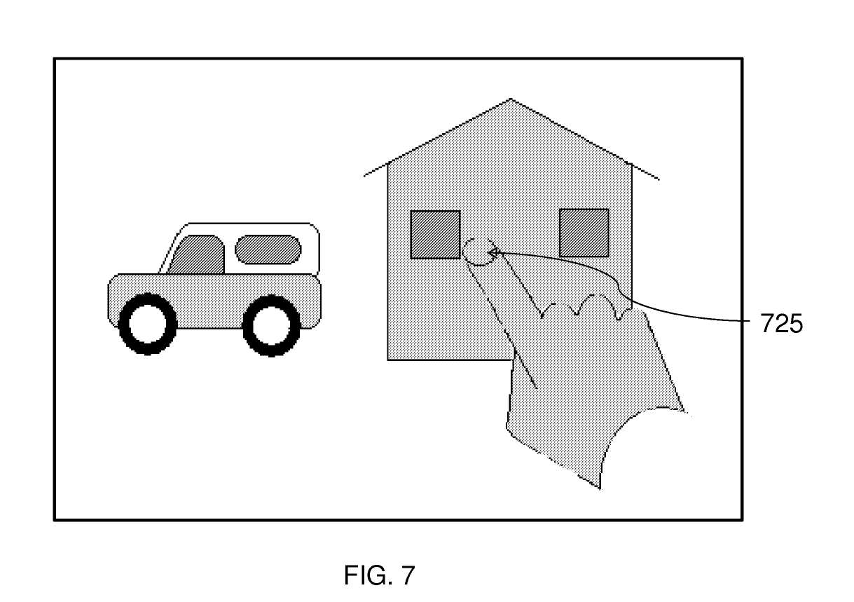

The displayed image is then turned OFF or removed from the see-through head mounted display 100 so that the viewer only sees the see-through view. The viewer then indicates the same selected first object (the window in this example) with the viewer's finger 625 in the see-through view as shown in FIG. 6 and a third image is captured by the camera 120 that includes the scene in front of the viewer and the viewer's finger 725 as shown in FIG. 7. As with the second image, the viewer's finger 725 is not aligned with the selected first object (the window) in the third image due to the combined effects of misalignment of the camera 120 with the see-through view and also due to the different perspective of the scene provided by the camera 120 and the viewer's right eye. The lateral and longitudinal image adjustments (also known as image shifts) needed to align the displayed image and the see-through view are then determined by comparing the location of the viewer's finger 525 in the second image to the location of the viewer's finger 725 in the third image. Methods for comparing images to align images based on corresponding objects in the images are described for example in U.S. Pat. No. 7,755,667. The determined lateral and longitudinal image adjustments are then applied to further displayed images to align the displayed images laterally and longitudinally with the see-through view.

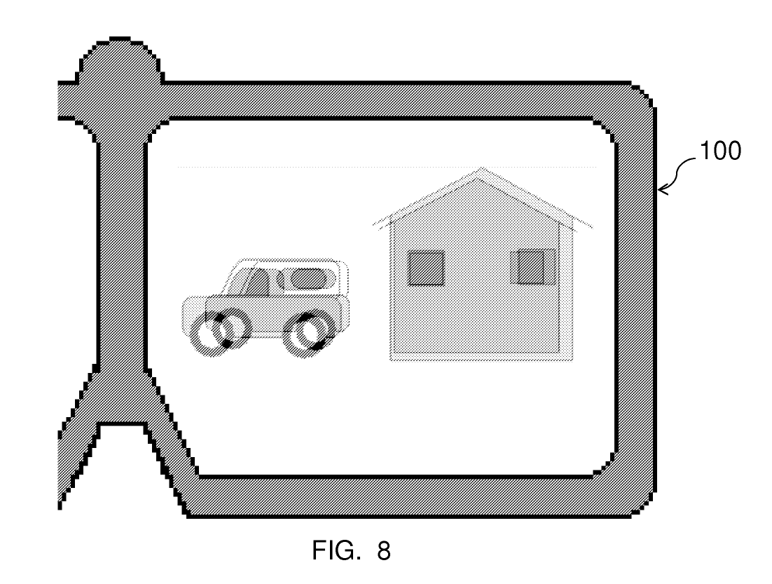

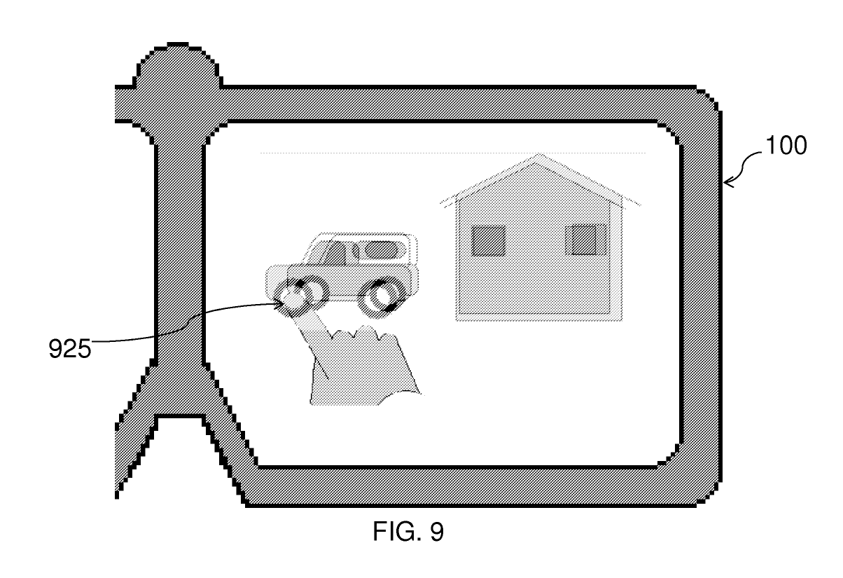

FIG. 8 is an illustration of a combined view as seen by the viewer's right eye wherein the displayed first image of the scene is overlaid on the see-through view of the scene and the first image has been aligned on the first object (the window). However in this case, as can be seen in FIG. 8, objects in the displayed image are not the same size as the see-through view and as a result, objects other than the selected first object are still not aligned. To determine the image adjustments needed to align the rest of the displayed image with the see-through view by resizing the displayed image, a second object (in this example, the car tire) is selected by the viewer and the viewer uses their finger 925 to indicate the location of the object in the displayed image as shown in FIG. 9.

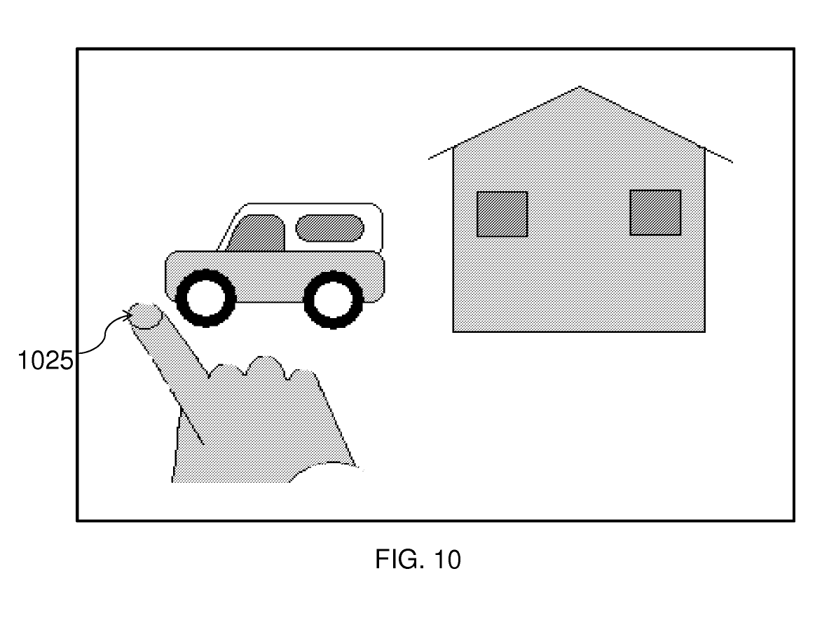

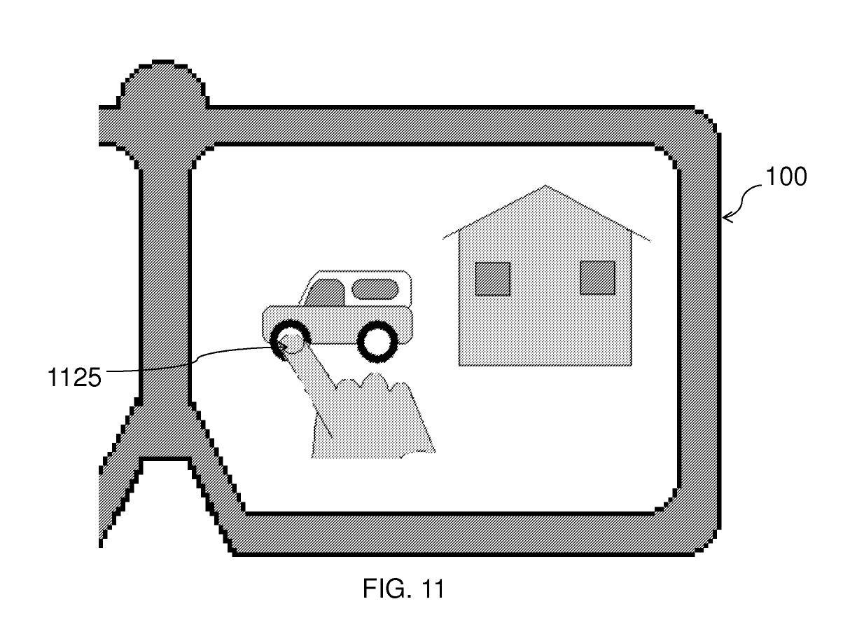

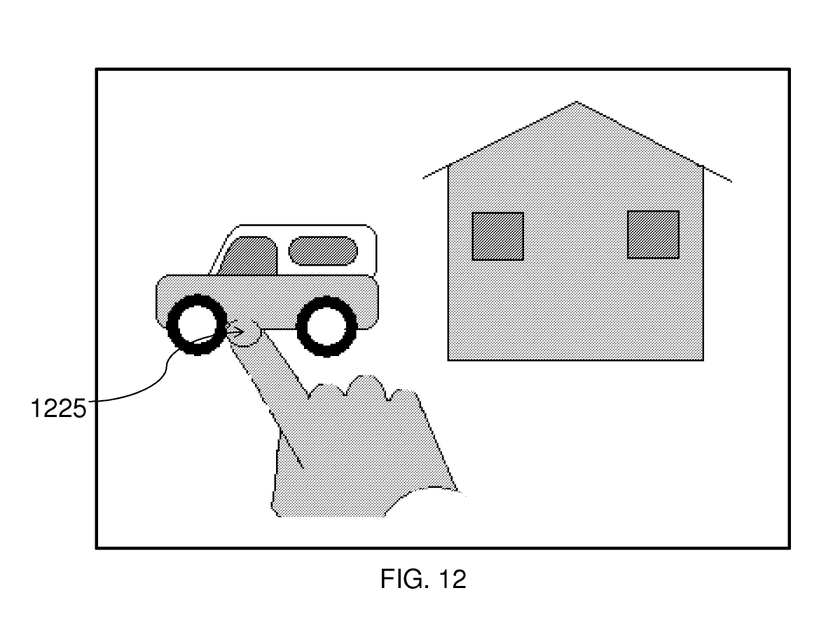

A fourth image is then captured as shown in FIG. 10 which includes the scene and the viewer's finger 1025. The displayed image is then turned OFF or removed so that the viewer only sees the see-through view of the scene and the viewer uses their finger 1125 to indicate the perceived location of the second selected object in the see-through view as shown in FIG. 11. A fifth image is then captured as shown in FIG. 12 which includes the scene and the viewer's finger 1225. The fourth and fifth images are then compared to determine the respective locations of the viewer's finger 1025 and 1225 and then to determine the image adjustment needed to align the displayed image to the see-through view at the location of the second selected object (the car tire). The determined image adjustments for the locations of the second selected object are then used, along with the distance in the images between the selected first and second objects, to determine the resizing of the displayed image so that when combined with the previously determined lateral and longitudinal adjustments, the displayed image is substantially aligned over the display area 115 with the see-through view as seen by the viewer. The lateral and longitudinal adjustments are determined in terms of x and y pixels shifts.

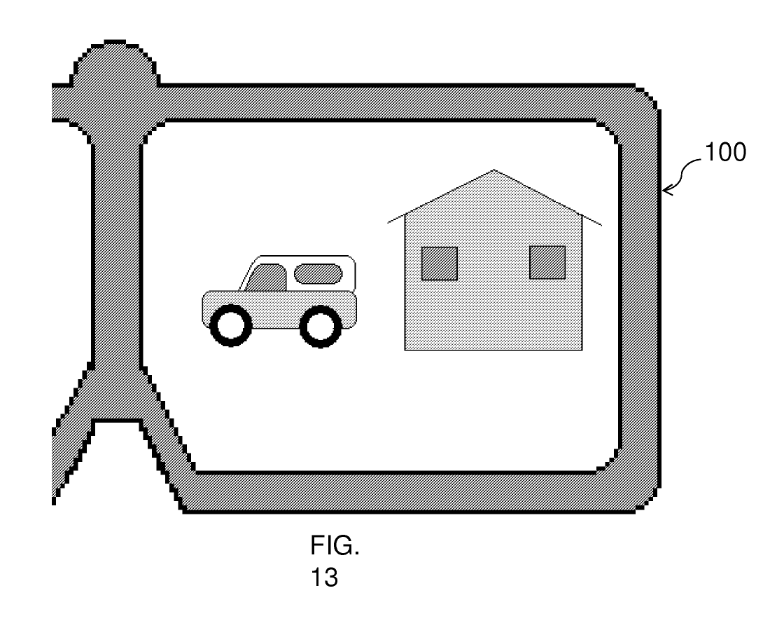

The resizing is then determined as the relative or percent change in the distance between the locations of the viewer's finger 525 and 1125 in the third and fourth images compared to the distance between the locations of the viewer's finger 525 and 1225 in the third and fifth images respectively. The percent change is applied to the displayed image to resize the displayed image in terms of the number of pixels. In an alternate method, the resizing of the displayed image is done before the alignment at a location in the displayed image. FIG. 13 shows an illustration of the displayed image overlaid on the see-through view wherein the displayed image has been aligned on the window object and then resized to align the remaining objects so that the combined image has essentially no perceived misalignments between the displayed image and the see-through view.

The timing of the multiple images that are captured in the method of the present invention can be executed automatically or manually. For example, the captures can be executed every two seconds until all the images needed to determine the image adjustments have been captured. By separating the captures by two seconds, the viewer has time to evaluate the misalignment and provide an indication of the misalignment. Alternately, the viewer can provide a manual indication to the see-through head mounted display device 100 when the viewer is satisfied that the misalignment has been properly indicated. The manual indication can take the form of pushing a button on the see-through head mounted display device 100 for example. Images can be displayed to the viewer with instructions on what to do and when to do it.

It should be noted that the methods disclosed herein for determining image adjustments to reduce misalignments between displayed images and see-through views are possible because the misalignments are largely due to angular differences in the locations and sizes of objects in the captured images from the camera 120 and the locations and sizes of corresponding objects in the see-through view. Since both the camera 120 and the viewer's eye perceive images in angular segments within their respective fields of view, angular adjustments on the displayed image can be implemented in terms of pixel shifts and pixel count changes or image size changes of the displayed image. Thus, the image adjustments can take the form of x and y pixel shifts in the displayed image along with upsampling or downsampling of the displayed image to increase or decrease the number of x and y pixels in the displayed image.

While the example described above covers the case where misalignments between the displayed image and the see-through view come from lateral and longitudinal misalignment as well as size differences, more complicated misalignments are possible from distortions or rotations. Rotational misalignments can be determined in the process of determining the resizing needed when comparing the fourth and fifth captured images.

Determining image adjustments needed to align displayed images to the see-through view when there is a distortion in either the displayed image or the see-through view requires gathering more information. In this case, the viewer would need to select at least one more object in a different location from the first or second object and repeat the process described above.

The examples provided describe methods for determining image adjustments based on the view from one eye. These determined image adjustments can be applied to the displayed images in both eyes or the image adjustments can be determined independently for each eye.

After the image adjustments have been determined, displayed images can be modified to compensate for misalignments. The displayed images can be still images or video. Further images of the scene can be captured to enable objects to be identified and the locations of objects in the further images to be determined. Where methods for identifying objects and determining the locations of objects in images are described for example in U.S. Pat. No. 7,805,003. Augmented image information can be displayed relative to the determined locations of the objects such that the augmented image information is aligned with the objects in the see-through view by including the image adjustments in the displayed images. In another embodiment, to save power when displaying augmented image information, additional further images of the scene are captured only when movement of the viewer or the see-through head mounted display device 100 is detected, as the determined locations of objects in the further images are unchanged when the viewer or the see-through head mounted display device 100 is stationary. When the viewer or the see-through head mounted display device 100 is stationary, the same image adjustments can be used for multiple displays of augmented image information to align the augmented image information with the objects as seen by the viewer in the see-through view.

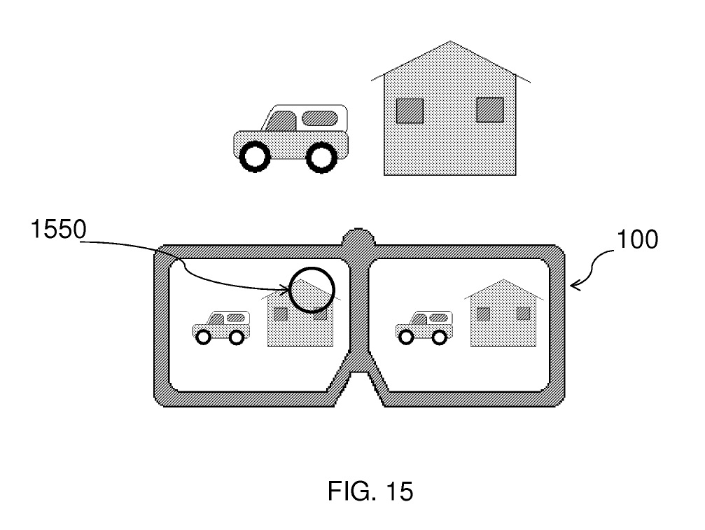

In another method, the viewer indicates the misalignment between a displayed image and the see-through view by moving their head. Illustrations of this method are shown in FIGS. 15-20. One or more locations are then chosen in the combined image seen by the viewer where an alignment can be performed. If more than one location is used for the alignment, the locations must be in different portions of the combined image, such as near opposite corners. To aid the viewer in selecting the locations used for performing the alignment, in one embodiment, a marker is provided in the displayed image as shown in FIG. 15 where the marker 1550 is a circle.

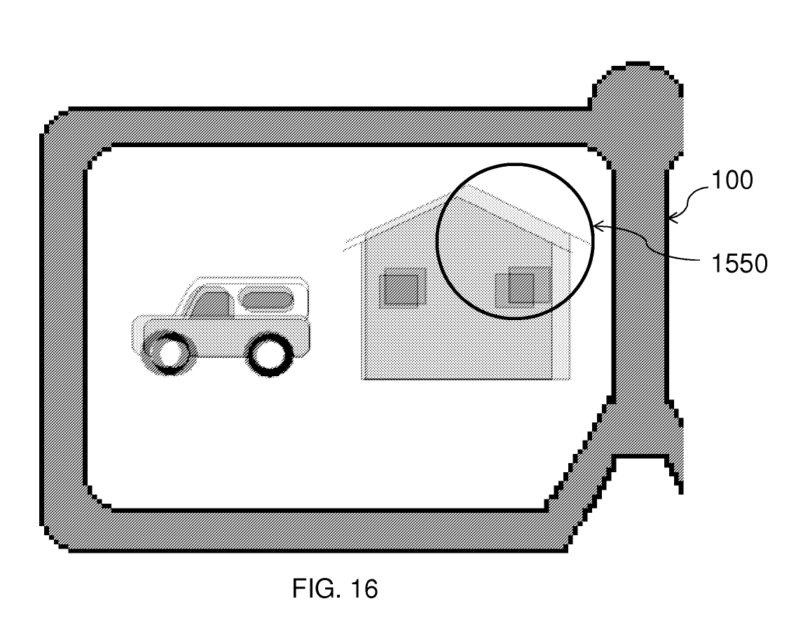

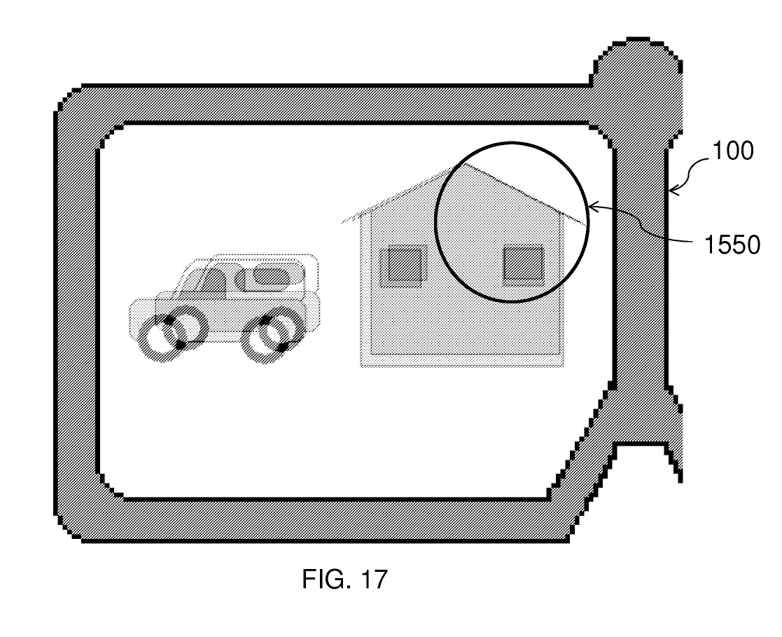

The displayed image shown in FIG. 15 on the see-through head mounted display device 100 is a first image captured of the scene by the camera 120 and the displayed image is shown from behind and slightly above the viewer's perspective so that objects in the scene can be seen as well as the displayed image. FIG. 16 is an illustration of the combined view as seen by the viewer in the left eye wherein the displayed image of the scene is overlaid on the see-through view of the scene and a misalignment can be seen. A marker 1550 indicates a first area for alignment. FIG. 17 illustrates a combined view as seen by a viewer's left eye wherein the viewer has moved his or her head to align objects (the roof) in the displayed image and see-through view in the area of the marker 1550.

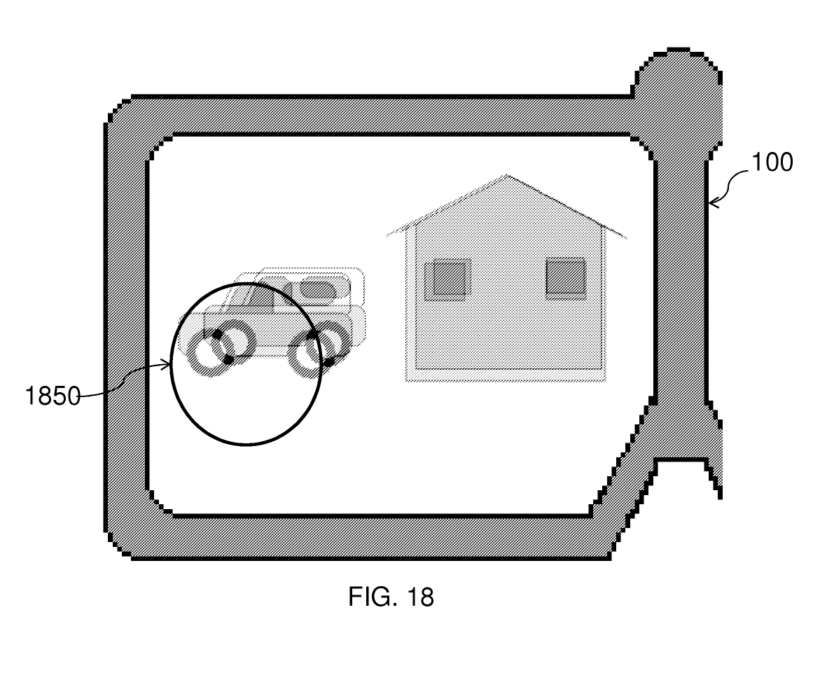

A second image is then captured by the camera 120. The first captured image is then compared to the second captured image by the electronics 125 including the processor to determine the difference between the two images in the location of the marker 1550. At this point, the displayed image and the see-through view would be aligned if the perceived sizes of the displayed image and the see-through view were the same and the determined the difference between the first and second captured images is an image adjustment of an x and y pixel shift on the displayed image. If there are still misalignments between the displayed image and the see-through view after an alignment at the location of the marker 1550 as shown in FIG. 17, then a second alignment is performed at a second marker 1850 as shown in FIG. 18.

As can be seen in FIG. 18, the two images are aligned at the location where marker 1550 had been located, but the remainder of the image has misalignments due to a mismatch in sizes between the displayed image and the see-through view. The viewer then moves his or her head to align objects in the displayed image to corresponding objects (such as the car tire) in the see-through view in the region of the marker 1850 to indicate the further image adjustment that is a resizing of the displayed image.

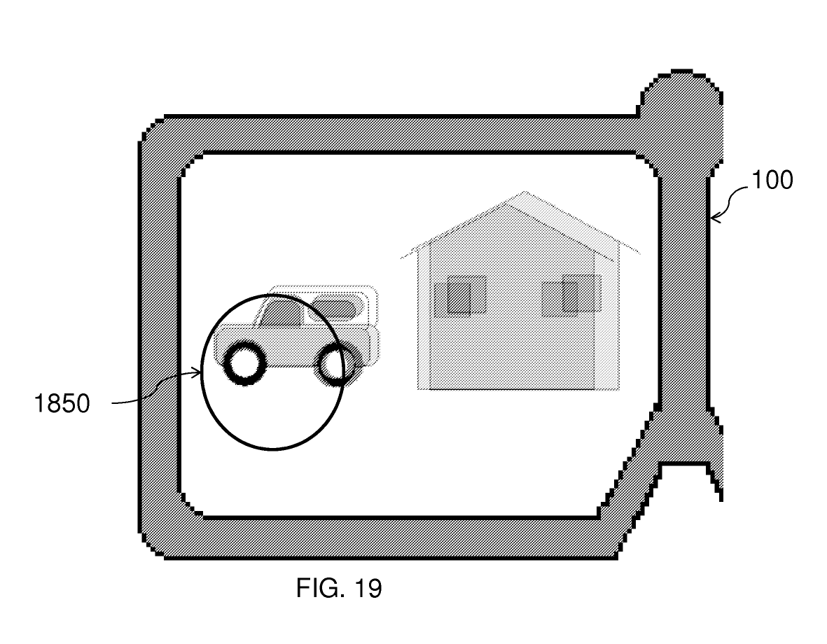

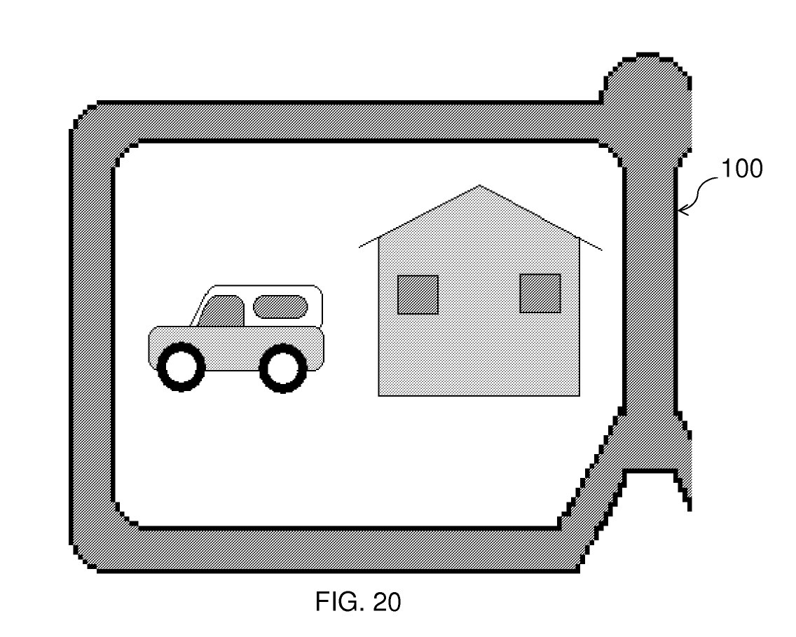

FIG. 19 shows an illustration of the combined image seen by the viewer after the viewer's head has been moved to align objects in the displayed to corresponding objects in the see-through view. A third image is then captured by the camera 120. The third image is then compared to the second image or the first image by the electronics 125 including the processor to determine the image adjustment needed to align the displayed image to the see-through view in the region of the second marker 1850. The image adjustment determined to align the displayed image to the see-through view at the region of the first marker 1550 is then a pixel shift. The percent change in the distance between the locations of objects in the area of the first and second markers when aligning the displayed image to the see-through view in the region of the second marker 1850 is the image adjustment for resizing the displayed image. FIG. 20 then shows the fully aligned displayed image, after applying the pixel shift and the resizing, overlaid on the see-through view as seen by the viewer, where misalignments are not visible.

The method of alignment can be further described in relation to the flow chart shown in FIG. 21. In Step 2110, the viewer looks at a scene and the camera 120 captures an image of the scene in Step 2120. The captured image is then displayed on the display areas 115 of the see-through head mounted display device 100 operating in a transparent or semi-transparent mode in Step 2130 so the viewer sees a combined view comprised of the displayed image overlaid on the see-through view. The viewer then provides an indication of the misalignment between objects in the displayed image and corresponding objects in the see-through view in Step 2140. The indication of the misalignments can be done by a series of finger gestures or by moving the viewer's head as described previously. The camera 120 is used to capture additional images of the scene along with the viewer's indication of the misalignments in Step 2150. Then in Step 2160, the captured additional images are compared in the electronics 125 to determine the image adjustments needed to align the displayed images with the see-through view as seen by the viewer.

In a further embodiment, the viewer indicates misalignments between captured images of the scene and the see-through view by a combination of hand gestures and head movement. One or more additional images are captured and compared to determine the image adjustments as previously described.

In another embodiment, the see-through head mounted display device 100 includes a GPS device or a magnetometer. The GPS device provides data on the current location or previous locations of the see-through head mounted display device 100. The magnetometer provides data on the current direction and previous directions of the viewer's line of sight. The data from the GPS or magnetometer or the combination of data from the GPS and magnetometer can be used to help identify objects in the scene or to determine the addresses or locations of objects in the images captured by the camera 120. By aligning the displayed image to the see-through view, augmented image information related to the identified objects can be provided in the combined view that is aligned to the respective objects as perceived by the viewer.

After alignment augmented image information can be aligned with identified objects in the captured images and identified edges of objects in the captured images. In addition, in see-through head mounted display devices 100 that include head tracking devices, such as gyros or accelerometers, head tracking information can be used to adjust augmented image information and the location of augmented image information relative to objects in the displayed images.

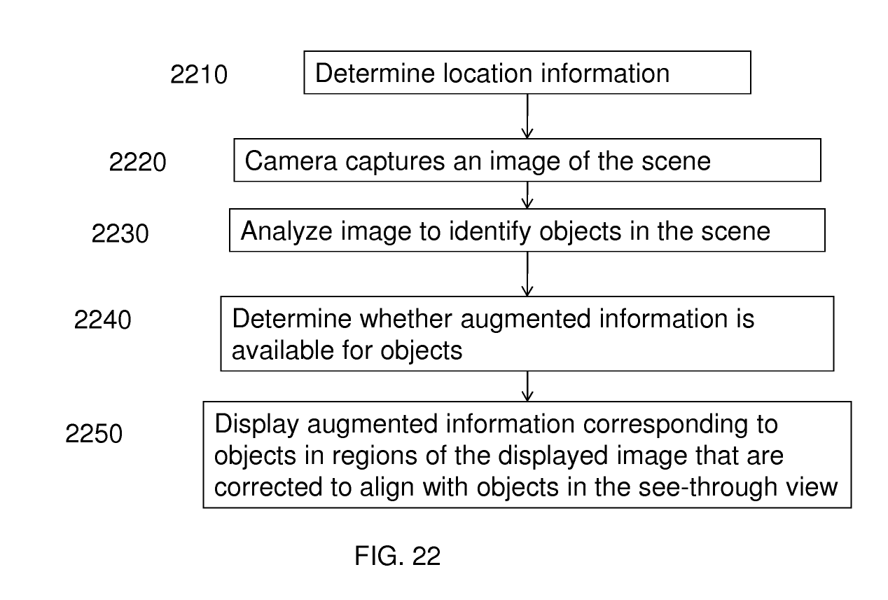

FIG. 22 shows a flow chart for using a see-through head mounted display device 100 with a GPS or magnetometer wherein the displayed image has been aligned with the see-through view as perceived by the viewer. In Step 2210, the GPS or magnetometer is used to determine the location of the viewer or the direction that the viewer is looking. The camera 120 then captures an image of the scene in Step 2220. The electronics 125 including the processor are then used to analyze the captured image along with the determined location or direction information to identify objects in the scene in Step 2230. The see-through head mounted display device 100 then uses the peripheral electronics 127 including a wireless connection to determine whether augmented information is available for the identified objects or the determined location or determined direction in Step 2240. In Step 2250, available augmented information is displayed in regions or locations of the displayed image that correspond to the objects locations when aligned to the see-through view.

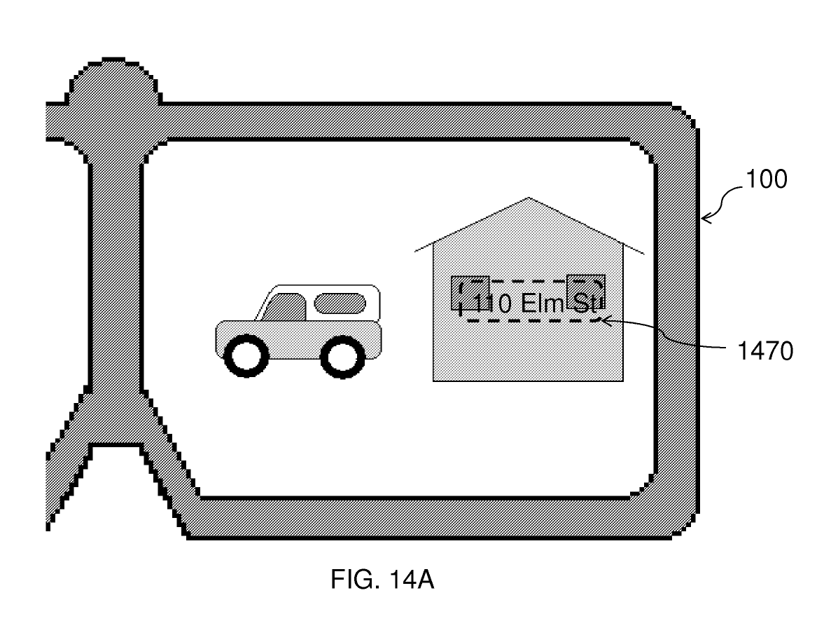

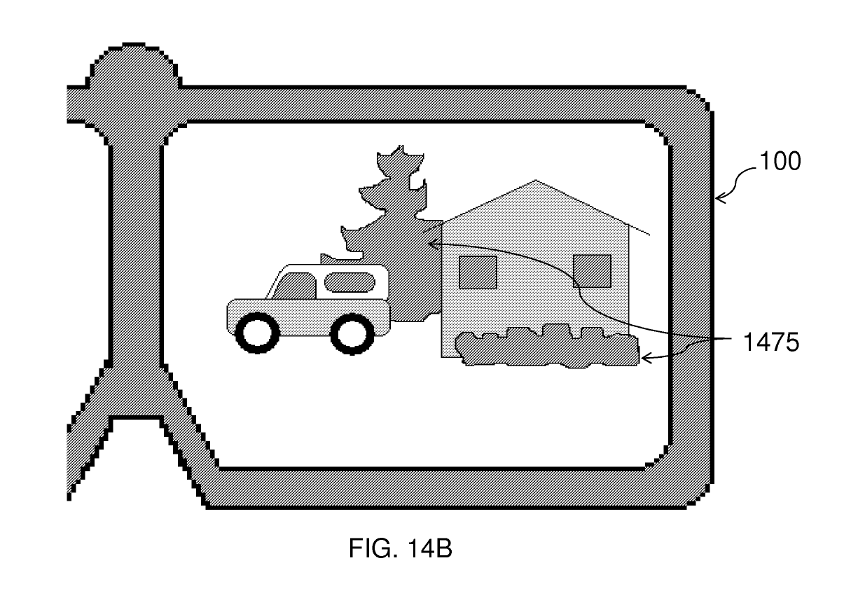

For example, a house can be identified in the captured image by the combination of its shape in the captured image and from the GPS location and the direction, the address of the house can then be determined from a map that is available on the internet and the address can be presented in the displayed image such that it overlays the region of the see-through view that contains the house (see FIG. 14A). In a further example, an image can be captured of a building. GPS data and magnetometer data can be used to determine the approximate GPS location of the building. Augmented information including the name of the building and ongoing activities in the building can be determined from information available from a server in the building that broadcasts over Bluetooth by matching the GPS location and the direction the viewer is looking. A displayed image is then prepared with the name of the building and a list of ongoing activities located in the region of the displayed image that corresponds to the aligned location of the building in the see-through view. An augmented image is then presented to the viewer as a combined image with the displayed image overlaid on the see-through view.

The augmented images produced by the these methods can be used for a variety of applications. In an embodiment, the augmented image can be part of a user interface wherein the augmented image information is a virtual keyboard that is operated by the viewer with finger gestures. In this example, the virtual keyboard needs to be aligned with the see-through view of the viewer's fingers for the viewer to select the desired keys. In another embodiment, the locations of the objects can be determined with the aid of GPS data or magnetometer data and the augmented image information can be advertising or names of objects or addresses of objects. The objects can be buildings, exhibitions or tourist attractions where the viewer uses the augmented image to aid making a decision on where to go or what to do. This information should be aligned with the see-through view of the buildings, exhibitions or tourist attractions.

FIG. 14A is an illustration of a combined view augmented reality image as seen by the viewer's right eye wherein a displayed label 1470 (the address) is overlaid onto an object (the house) in the see-through view and the displayed label 1470 is aligned to the object. In a further embodiment, the augmented image includes directions or procedural information related to the objects in the scene and the directions or procedural information needs to be aligned to the objects so the viewer can perform an operation properly. In yet another embodiment, the augmented image can be a modified version of the scene in which objects have been added to form a virtual image of the scene. FIG. 14B is an illustration of a combined view augmented reality image as seen by the viewer's right eye wherein augmented image information in the form of displayed objects 1475 (the tree and bushes) are overlaid onto objects (the car and house) in the see-through view and the displayed objects 1475 are aligned to the objects in the see-through view.

Table of numerals for figures

| | |
|---|---|
| 100 | See-through head |
| | mounted display device |
| 102 | Lens |
| 105 | Frame |
| 110 | Clear lens area |
| 115 | Display area |
| 120 | Camera |
| 125 | Electronics |
| | including a processor |
| 127 | Peripheral |
| | electronics including |
| | wireless connection and |
| | image storage |
| 130 | Arms |
| 240 | Object in displayed |
| | image |
| 245 | Displayed image in |
| | left eye |
| 250 | Displayed image in |
| | right eye |
| 342 | Object in |
| | displayed image |
| 425 | Viewer's finger |
| 525 | Viewer's finger |
| 625 | Viewer's finger |
| 725 | Viewer's finger |
| 925 | Viewer's finger |
| 1025 | Viewer's finger |
| 1125 | Viewer's finger |
| 1225 | Viewer's finger |
| 1470 | Displayed label |
| 1475 | Displayed |
| | objects |
| 1550 | Marker |
| 1850 | Marker |
| 2110 | Viewer look at scene step |
| 2120 | Camera capture image of |
| | scene step |
| 2130 | Display captured image step |
| 2140 | Viewer indicates |
| | misalignments step |
| | determine image adjustments needed |
| | step |
| 2150 | Camera captures additional |
| | images with viewer indications step |
| 2160 | Compare captured images |
| | with indications to determine image |
| | adjustments needed step |
| 2210 | Determine location step |
| 2220 | Capture an image of the |
| | scene step |
| 2230 | Analyze the captured image |
| | to identify objects step |
| 2240 | Determine whether |
| | augmented information is available |
| | for identified objects step |
| 2250 | Display augmented |
| | information for identified objects in |
| | regions of the displayed image that |
| | correspond to the regions of the |
| | displayed that are aligned with the |
| | see-through view step |

This disclosure has been made in detail with particular reference to certain embodiments, but it will be understood that variations and modifications can be effected within the spirit and scope of the invention.

What is claimed is:

1. A method for providing an augmented image in a see-through head mounted display which includes a camera comprising:
capturing a first image of a scene with the camera wherein the scene contains objects;
displaying the first image to a viewer;
capturing one or more additional image(s) of the scene with the camera in which the viewer indicates a misalignment between the displayed first image and a see-through view of the scene;
comparing the captured images to determine an image adjustment to align corresponding objects in the first image to the objects in the see-through view of the scene;
providing augmented image information;
applying the determined image adjustments to the augmented image information; and
displaying the augmented image information so the viewer sees an augmented image comprised of the augmented image information overlaid on the see-through view.

2. The method of claim 1 wherein the image adjustment comprises a lateral shift, a longitudinal shift or a resizing.

3. The method of claim 1 wherein the viewer indicates the misalignment by a hand gesture that is captured in the one or more additional image(s) of the scene.

4. The method of claim 1 wherein the viewer indicates the misalignment by moving his or her head between captured images.

5. The method of claim 1 wherein the viewer indicates misalignments at two or more different locations in the see-through view of the scene.

6. The method of claim 1 further comprising:
capturing another image of a scene with the camera;
analyzing the another image to identify the locations of objects in the scene; and
providing augmented image information using the determined image adjustments so the augmented image information is aligned to objects in the scene.

7. The method of claim 6, further comprising identifying the objects.

8. The method of claim 7 wherein the augmented image information is related to the objects in the scene.

9. The method of claim 1 further comprising:
capturing another image of the scene;
analyzing the another image and using the determined image adjustment to determine the locations of objects in the see-through view;
providing augmented image information;
applying the determined image adjustment to the augmented image information;
displaying the augmented image information so the viewer sees another augmented image comprised of the augmented image information overlaid on the see-through view; and
repeating these steps for additional other images to provide an augmented video.

10. The method of claim 9 wherein the see-through head mounted display further includes a GPS sensor or a magnetometer; and the locations of objects are further determined by using data provided by the GPS sensor or the magnetometer.

11. The method of claim 9 wherein the see-through head mounted display further includes a gyro or an accelerometer; and the locations of objects are further determined by using data provided by the gyro or accelerometer.

12. The method of claim 1 wherein the augmented image is part of user interface.

13. The method of claim 8 wherein the augmented image includes instructions.

14. The method of claim 8 wherein the augmented image includes names or addresses of objects.

15. The method of claim 1 wherein the viewer indicates the misalignment by a combination of hand gesture and head movement.

16. The method of claim 9 wherein the capturing of additional another images of the scene and analyzing of the additional another images is done when movement of the viewer is detected.

17. The method of claim 1 wherein instructions are displayed to the viewer.
